(19) United States
(12) Patent Application Publication
(10) Pub. No.: US 2024/0257187 A1
(43) Pub. Date: Aug. 1, 2024

(54) METHODS, SYSTEMS, AND MEDIA FOR PROVIDING CONTENT PROVIDERS WITH CONTEXTUAL INFORMATION ASSOCIATED WITH DYNAMIC CONTENT

(71) Applicant: Integral Ad Science, Inc., New York, NY (US)

(72) Inventors: Vikram Gupta, Pune (IN); Prashant Jawale, Pune (IN); Bhavin Shah, Pune (IN)

(21) Appl. No.: 18/426,671

(22) Filed: Jan. 30, 2024

Related U.S. Application Data
(60) Provisional application No. 63/442,051, filed on Jan. 30, 2023.
(60) Provisional application No. 63/442,684, filed on Feb. 1, 2023.

(51) Int. Cl. G06Q 30/0241; G06F 18/241; G06Q 30/0273

(52) U.S. Cl. CPC G06Q 30/0277; G06F 18/241; G06Q 30/0275

(57) ABSTRACT

Methods, systems, and media for providing content providers with contextual information associated with dynamic content are provided. In some embodiments, the method includes: accessing a webpage that contains at least one dynamic advertising region; receiving a plurality of brand sentiments associated with a first advertiser; identifying a position of the at least one dynamic advertising region in the webpage and at least one content item shown in proximity to the at least one dynamic advertising region; determining, using a machine learning classifier, (i) a plurality of sentiments for the at least one content item shown in proximity to the at least one dynamic advertising region, (ii) a plurality of similarity scores, wherein each similarity score is a probability that a sentiment from the plurality of sentiments for the at least one content item is similar to a sentiment from the plurality of brand sentiments, and (iii) an aggregate similarity score based on the plurality of similarity scores; and, in response to determining that the aggregate similarity score is within a first range of predetermined values, associating the webpage with an approval list associated with the first advertiser.

### CROSS-REFERENCE TO RELATED APPLICATIONS

This application claims the benefit of U.S. Provisional Patent Application No. 63/442,051, filed Jan. 30, 2023, and claims the benefit of U.S. Provisional Patent Application No. 63/442,684, filed Feb. 1, 2023, each of which is incorporated by reference herein in its entirety.

### TECHNICAL FIELD

The disclosed subject matter relates to methods, systems, and media for providing content providers with contextual information associated with dynamic content.

### BACKGROUND

Digital advertising is included in many aspects of web content, such as, for example, display advertising on webpages, sponsored links to a brand's page in a search result, and video advertisements which play before, during, or after a video. Advertisers often place their advertising content in a digital advertising region based on prior information regarding the content on the webpage and/or video. Such prior information can be provided by an advertising network which auctions digital advertising placement or a platform which helps pair the advertiser content with a digital advertising region. The platform can scan a particular webpage and analyze the content, for example, of a blog post. Then, by summarizing the content in a scoring or tagging system, advertisers can understand the context of the webpage, and the context in which their advertisements can appear.

However, many webpages have multiple digital advertising regions and an advertiser can unknowingly display their own brand in one digital advertisement that is located next to a second digital advertisement. The second digital advertisement can be used for advertisements of a brand that is in opposition to what the advertiser is promoting. For example, a display advertisement for animal welfare can be displayed on the same webpage or within the same video as a display advertisement for a hamburger provided by a fast-food restaurant. Thus, the content of dynamic aspects of a webpage, such as dynamic advertising regions, are often unavailable to advertisers before the advertiser submits a request or a bid to advertise on a particular webpage.

Accordingly, it is desirable to provide new mechanisms for providing content providers with contextual information associated with dynamic content.

### SUMMARY

Methods, systems, and media for providing content providers with contextual information associated with dynamic content are provided.

In accordance with some embodiments of the disclosed subject matter, a method for providing contextual information associated with pages containing dynamic content is provided, the method comprising: accessing a webpage that contains at least one dynamic advertising region; receiving a plurality of brand sentiments associated with a first advertiser; identifying a position of the at least one dynamic advertising region in the webpage and at least one content item shown in proximity to the at least one dynamic advertising region; determining, using a machine learning classifier, (i) a plurality of sentiments for the at least one content item shown in proximity to the at least one dynamic advertising region, (ii) a plurality of similarity scores, wherein each similarity score is a probability that a sentiment from the plurality of sentiments for the at least one content item is similar to a sentiment from the plurality of brand sentiments, and (iii) an aggregate similarity score based on the plurality of similarity scores; and, in response to determining that the aggregate similarity score is within a first range of predetermined values, associating the webpage with an approval list associated with the first advertiser.

In some embodiments, the method further comprises causing the first advertiser to place a bid for advertising in the at least one dynamic advertising region on the webpage in response to the webpage being associated with the approval list.

In some embodiments, the method further comprises: determining that the aggregate similarity score based on the plurality of similarity scores is within a second range of predetermined values, wherein the second predetermined range of values does not overlap with the first predetermined range of values; and, in response to determining the aggregate similarity score is within the second range of predetermined values, associating the webpage with an exclusion list associated with the first advertiser.

In some embodiments, the method further comprises inhibiting the first advertiser from placing a bid for advertising in the at least one dynamic advertising region on the webpage in response to the webpage being associated with the exclusion list.

In some embodiments, the method further comprises: determining, prior to accessing to the webpage that contains the at least one dynamic advertising region, that the webpage is included on an exclusion list associated with the first advertiser; and, in response to determining that the aggregate similarity score associated with the webpage is within the first predetermined range of values, removing the webpage from the exclusion list associated with the first advertiser and adding the webpage on the approval list associated with the first advertiser.

In some embodiments, the method further comprises: determining, prior to accessing to the webpage that contains the at least one dynamic advertising region, that the webpage is included on the approval list associated with the first advertiser; and, in response to determining that the aggregate similarity score associated with the webpage is within a second predetermined range of values, removing the webpage from the approval list associated with the first advertiser and adding the webpage on an exclusion list associated with the first advertiser.

In some embodiments, the aggregate similarity score is a weighted sum of the plurality of similarity scores, wherein the position of the at least one dynamic advertising region is used to weight the plurality of similarity scores.

In some embodiments, the webpage is selected based on a determination that the webpage contains content that is relevant for the first advertiser.

In some embodiments, the method further comprises associating the plurality of advertising sentiments, the at least one content item, the plurality of sentiments for the at least one content item, the plurality of similarity scores, and the aggregate similarity score with a training dataset for the machine learning model.

In accordance with some embodiments of the disclosed subject matter, a system for providing contextual information associated with pages containing dynamic content is provided, the system comprising a hardware processor that is configured to: access a webpage that contains at least one dynamic advertising region; receive a plurality of brand sentiments associated with a first advertiser; identify a position of the at least one dynamic advertising region in the webpage and at least one content item shown in proximity to the at least one dynamic advertising region; determine, using a machine learning classifier, (i) a plurality of sentiments for the at least one content item shown in proximity to the at least one dynamic advertising region, (ii) a plurality of similarity scores, wherein each similarity score is a probability that a sentiment from the plurality of sentiments for the at least one content item is similar to a sentiment from the plurality of brand sentiments, and (iii) an aggregate similarity score based on the plurality of similarity scores; and, in response to determining that the aggregate similarity score is within a first range of predetermined values, associate the webpage with an approval list associated with the first advertiser.

In accordance with some embodiments of the disclosed subject matter, a computer-readable medium containing computer executable instructions that, when executed by a processor, cause the processor to perform a method for providing contextual information associated with pages containing dynamic content is provided, the method comprising: accessing a webpage that contains at least one dynamic advertising region; receiving a plurality of brand sentiments associated with a first advertiser; identifying a position of the at least one dynamic advertising region in the webpage and at least one content item shown in proximity to the at least one dynamic advertising region; determining, using a machine learning classifier, (i) a plurality of sentiments for the at least one content item shown in proximity to the at least one dynamic advertising region, (ii) a plurality of similarity scores, wherein each similarity score is a probability that a sentiment from the plurality of sentiments for the at least one content item is similar to a sentiment from the plurality of brand sentiments, and (iii) an aggregate similarity score based on the plurality of similarity scores; and, in response to determining that the aggregate similarity score is within a first range of predetermined values, associating the webpage with an approval list associated with the first advertiser.

In accordance with some embodiments of the disclosed subject matter, a system for providing contextual information associated with pages containing dynamic content is provided, the system comprising: means for accessing a webpage that contains at least one dynamic advertising region; means for receiving a plurality of brand sentiments associated with a first advertiser; means for identifying a position of the at least one dynamic advertising region in the webpage and at least one content item shown in proximity to the at least one dynamic advertising region; means for determining, using a machine learning classifier, (i) a plurality of sentiments for the at least one content item shown in proximity to the at least one dynamic advertising region, (ii) a plurality of similarity scores, wherein each similarity score is a probability that a sentiment from the plurality of sentiments for the at least one content item is similar to a sentiment from the plurality of brand sentiments, and (iii) an aggregate similarity score based on the plurality of similarity scores; and means for associating the webpage with an approval list associated with the first advertiser in response to determining that the aggregate similarity score is within a first range of predetermined values.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is an example flow diagram of a method for providing content providers with contextual information associated with dynamic content in accordance with some embodiments of the disclosed subject matter.

FIG. 2 is an illustrative webpage containing dynamic advertising regions in accordance with some embodiments of the disclosed subject matter.

FIG. 3 is a series of examples of dynamic advertising content items in accordance with some embodiments of the disclosed subject matter.

FIG. 4 is an example block diagram of a system that can be used to implement mechanisms described herein in accordance with some embodiments of the disclosed subject matter.

FIG. 5 is an example block diagram of hardware that can be used in a server and/or a user device in accordance with some embodiments of the disclosed subject matter.

### DETAILED DESCRIPTION

In accordance with various embodiments of the disclosed subject matter, mechanisms (which can include methods, systems, and media) for providing content providers with contextual information associated with dynamic content.

Web pages, Internet-connected applications, and many other types of web content allow digital advertisements. For example, a website that hosts blogs can have templates that automatically populate regions of the displayed web page with advertisements. Many companies use digital advertising as a part of their overall marketing strategy, and different platforms exist that can sell the available digital advertising regions (such as blog pages) to advertisers. Web pages are typically analyzed by such platforms to find advertisers whose products and/or services match the interests of individuals that are likely to visit the web page. Such analysis is often performed by capturing or identifying the main content of the web page, such as the text and images used in a blog post or article.

A web page, however, often has multiple regions where different digital advertisements can be simultaneously displayed and such areas on a web page are not usually included when scoring or tagging web page content. This can be detrimental to a particular advertiser when their content appears next to or near another piece of digital advertising that promotes products and/or services that are in opposition to the particular advertiser.

As a particular example, a given web page can be an article describing the health benefits of eating animal meat. This page can be tagged and/or scored highly in categories that can attract advertisers associated with fast-food restaurants that sell food using animal meat. The same page, however, can also attract advertising attention for groups that wish to promote animal welfare. Thus, it is possible for a fast-food restaurant advertisement containing imagery of bacon, hamburgers, cheese, and/or other animal-derived food products to appear next to an advertisement for converting to veganism. In this example, the advertisement associated with the fast-food brand understood the context of the web page but was not aware of other advertisers who submitted (and subsequently won) bids for advertising elsewhere on the same web page.

Thus, a pre-bid solution can be described herein that can provide a content provider, such as an advertiser, with additional contextual information regarding other entities that may provide content (e.g., advertise) on the same webpage as the content provider.

In some embodiments, the mechanisms can identify regions of dynamic advertising within a web page, and can capture the imagery and/or content displayed in the dynamic advertising regions.

Additionally, in some embodiments, the mechanisms can use any suitable mechanism (such as a machine learning classifier) to determine a plurality of sentiments shown in the image, and can determine a separate set of sentiments for each image captured in a different advertising region on the webpage. The mechanisms can additionally determine (e.g., using the image sentiments) how similar the displayed image is compared to sentiments provided to the mechanisms by the advertiser. Then, the mechanisms can determine an aggregate similarity score that summarizes the webpage as being brand-safe or brand-unsafe for the particular advertiser. In some embodiments, the mechanisms can repeat the identification and analysis of dynamic regions within the webpage to generate a training dataset for the machine learning classifier.

In some embodiments, the mechanisms can cause a particular webpage to be added to an exclusion or approval list, which the advertiser can then reference in real-time when submitting bids for advertising on the particular webpage.

In some embodiments, the mechanisms can cause a particular webpage to be removed from the exclusion or approval list (where the webpage was placed after a previous instance of the mechanisms) after the mechanisms perform a current instance of the webpage analysis.

In some embodiments, the mechanisms can weight the aggregate similarity score according to where a given advertising image is positioned within the webpage. For example, if an advertiser always bids on a banner advertisement but a potentially brand un-safe advertisement is identified towards the bottom of a webpage, the webpage can still be determined to be brand-safe for the advertiser as the potentially brand un-safe advertisement is positioned far away from where the advertiser would place a display advertisement.

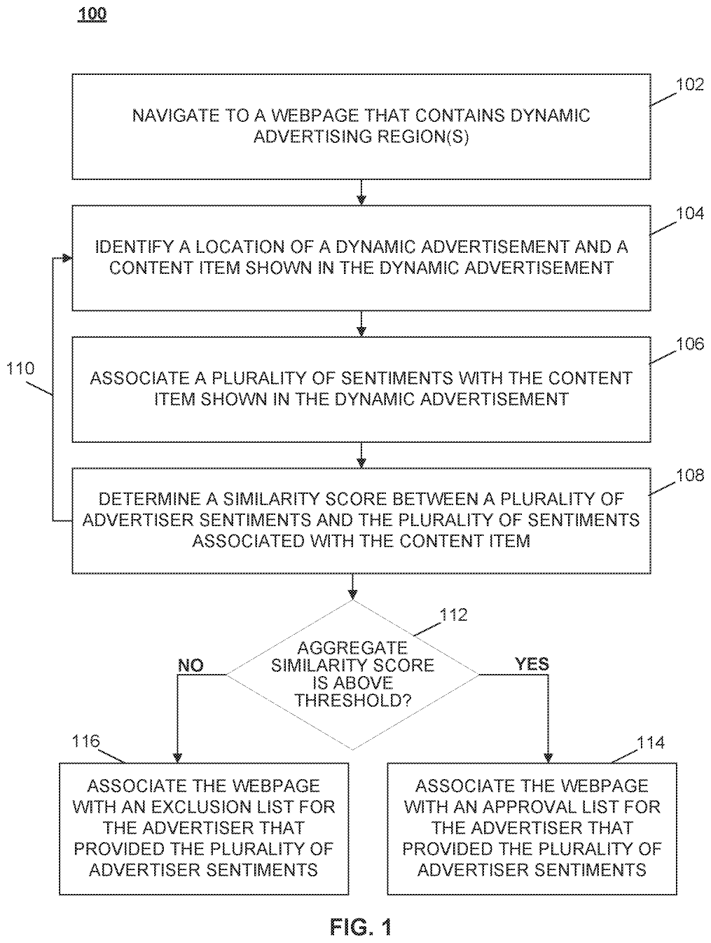

These and other features for providing content providers with contextual information associated with dynamic content are described further in connection with FIGS. 1-5.

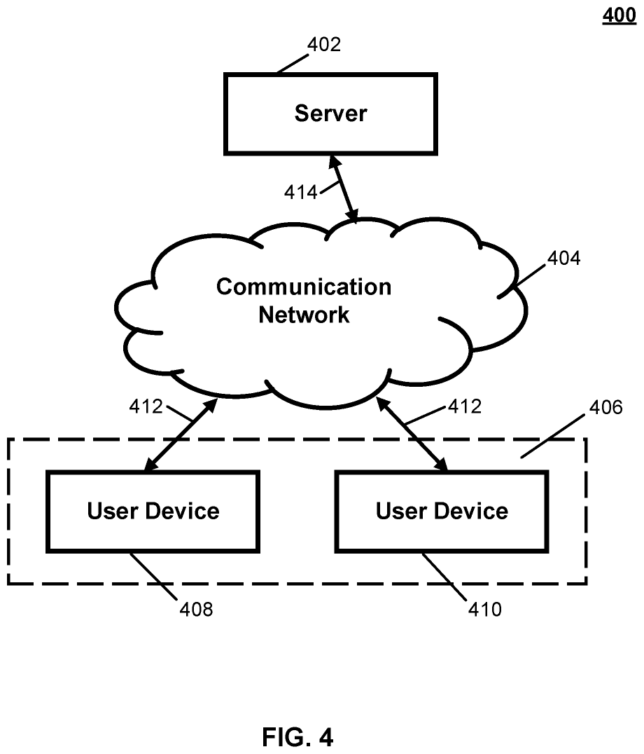

Turning to FIG. 1, an example flow diagram of an illustrative process 100 for providing content providers with contextual information associated with dynamic content in accordance with some embodiments of the disclosed subject matter is shown. In some embodiments, process 100 can be executed on any suitable device, such as server 402 and/or user devices 406 as discussed below in connection with FIG. 4.

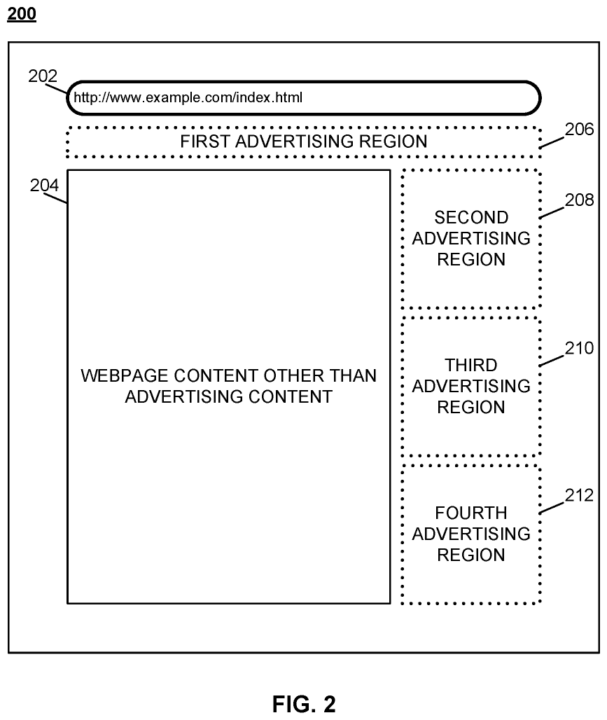

As shown, process 100 can begin at block 102 in some embodiments when a server and/or user device receives a web location, such as a web address 202 and/or universal resource locator (URL), as described below in FIG. 2. Note that, in some embodiments, process 102 can receive a web location that corresponds to an application, a video, and/or any other suitable type of web-hosted content. In some embodiments, process 100 can receive a web address from an advertising network, wherein an advertiser has requested a recommendation for submitting a bid to a particular webpage through the advertising network. In some embodiments, process 100 can receive the web address based on an existing approval or exclusion list for a particular advertiser, as discussed below at blocks 114 and 116, respectively. For example, in some embodiments, process 100 can periodically (e.g., once per day, once per week, once per month, etc.) review existing approval and/or exclusion lists for the advertiser and can re-analyze the webpage(s) included in such lists to ensure up-to date advertising context and recommendations for the advertiser.

In some embodiments, process 100 can navigate to the web location. In some embodiments, process 100 can verify that the web location contains one or more dynamic advertising regions. For example, in some embodiments, process 100 can identify references to dynamic advertisements (and/or advertising servers) in the underlying web design (e.g., HTML, CSS, Javascript, XML, etc.) of the webpage. In another example, in some embodiments, process 100 can use any suitable image analysis techniques to compare a previous instance of the same web address with the currently loaded instance of the web address received at block 102. That is, when a website has a dynamic advertising region, a first instance of the webpage can have a first advertisement in the dynamic advertising region, and a second instance of the webpage can have a second advertisement (e.g., with different text, colors, imagery, etc.) in the same position on the webpage. In some embodiments, process 100 can use the first instance and the second instance of the webpage to determine that the webpage contains dynamic advertising region(s).

In some embodiments, at block 104, process 100 can identify the position of the one or more dynamic advertising regions and can additionally identify a content item shown in each of the dynamic advertising region(s). For example, in some embodiments, process 100 can identify that a particular webpage has a “banner” region for display advertisements that can be updated with new advertising content periodically, and that a particular advertisement network is designated to populate the banner region with any suitable advertisement (e.g., image, video, interactive, pop-up, etc.). Continuing this example, in some embodiments, process 100 can identify that the banner region contains an advertisement for a particular product and/or service with associated imagery.

In some embodiments, at block 104, process 100 can identify multiple dynamic advertising regions, and can identify a position for each dynamic advertising region. For example, in some embodiments, process 100 can identify a banner advertising region at the top of the webpage, and can additionally identify two separate regions along the side of the webpage that contain dynamic advertisements.

In some embodiments, at block 104, process 100 can additionally create a record of the position of each dynamic advertisement identified within the webpage, and can additionally and/or optionally include a record of the type and/or copy of the image identified in the dynamic advertising region. In some embodiments, process 100 can identify the position using qualitative aspects (“top” of the webpage, “above” the navigation bar, etc.). In some embodiments, process 100 can identify the position by using quantitative aspects that can refer to an absolute position within the display area upon which the web page is shown (e.g., by referencing pixel coordinates and distances, etc.), and/or can refer to a relative position within the webpage (e.g., percent of the screen used, percentage placement relative to a title and/or menu bar displayed on the webpage, etc.).

In some embodiments, at block 104, process 100 can use any suitable mechanism to determine, for each of the dynamic advertising regions, a content item displayed in the dynamic advertising region. For example, in some embodiments, process 100 can use image capture to select a first region of dynamic advertising near the “top” of the webpage, and can store an indication of the image capture with an indication of the region where the indication was positioned on the webpage. In another example, in some embodiments, process 100 can use image capture to select the entire webpage and can identify two distinct images, one image (e.g., an ad for flying a particular airline) in the region of dynamic advertising near the “top” of the webpage and the second image in the region of dynamic advertising “above” the navigation bar (e.g., an ad for a weekend sale at a local retailer). In this example, in some embodiments, process 100 can perform any suitable image manipulation (e.g., crop, copy, paste, resize, markup, black-out regions, etc.) the initial image capture in order to identify the two distinct advertising images.

At block 106, process 100 can, in some embodiments, use any suitable image analysis technique to determine sentiments (e.g., tags and/or classification(s)) to the image(s) identified at block 104. For example, in some embodiments, process 100 can tag the image(s) displayed in the dynamic advertising regions according to a brand name and/or logo displayed in the image. In another example, in some embodiments, process 100 can classify the displayed image using subjective qualities (e.g., “positive”, “neutral”, “negative”) and/or using topical keywords (e.g., “beach”, “apparel sale”, etc.) based on the imagery and/or text that appears in the image. In some embodiments, process 100 can determine any suitable quantity of sentiments and can associate the determined sentiments with the image(s).

For example, in some embodiments, process 100 can determine at block 104 that there are three dynamic advertising regions on a webpage, and can identify a distinct content item in each dynamic advertising region for a total of three content items. Continuing this example, in some embodiments, process 100 can determine a plurality of sentiments for each of the three content items at block 106.

As a particular example, in some embodiments, at block 106, process 100 can determine that a first content item contains the following attributes {“airline logo and name,” “plane,” “positive,” “holiday,” “getaway,” “vacation”} based on an image that is advertising for a particular airline and can assign the attributes to the plurality of sentiments for the first content item. Continuing this particular example, in some embodiments, at block 106, process 100 can determine that a first content item contains the following attributes {“real estate,” “woman smiling,” “agency name,” “agency phone number” } based on an image that is advertising a particular real estate agent and/or agency and can assign the attributes to the plurality of sentiments for the second content item. Lastly, in this particular example, in some embodiments, at block 106, process 100 can determine that the third content item contains the following attributes {“retailer logo,” “sale,” “shopping bag,” “calendar dates” } based on an image that is advertising a weekend sale at a big-box retailer and can assign the attributes to the plurality of sentiments for the third content item.

Continuing to block 108, process 100 can determine a similarity score between a plurality of advertiser sentiments and the plurality of sentiments associated with each item. In some embodiments, process 100 can determine that the plurality of sentiments associated with an image in a dynamic advertising region is likely to be similar to the plurality of advertiser sentiments.

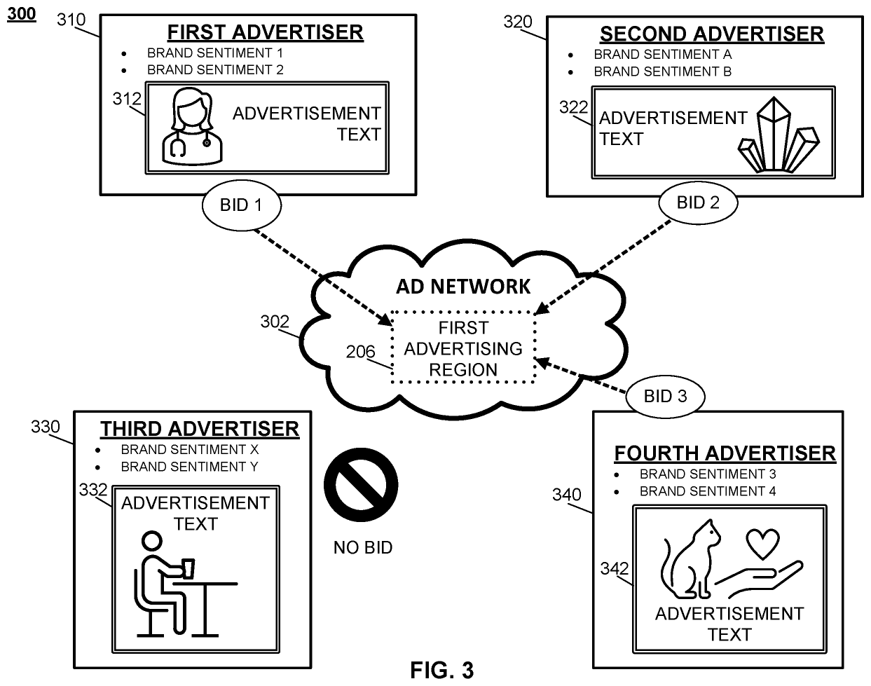

In some embodiments, the plurality of advertiser sentiments can comprise a series of individual words and/or phrases of any suitable length. In some embodiments, the plurality of advertiser sentiments can include attributes that the advertiser wants to be associated with the brand, agency, company, business, product, and/or service that is being advertised by the advertiser. For example, in some embodiments, the plurality of advertiser sentiments can include {“responsive to patients,” “evidence-based care”} as discussed below in connection with advertiser 310 as shown in FIG. 3.

In some embodiments, the plurality of advertiser sentiments can be received at block 108 and can be predetermined by the brand, agency, and/or advertiser. In some embodiments, the plurality of advertiser sentiments can be received in connection with any other block of process 100. For example, in some embodiments, the plurality of advertiser sentiments can be received at block 102 in connection with process 100 receiving the webpage.

In some embodiments, process 100 can, at block 108, determine a similarity score between the plurality of advertiser sentiments and the plurality of sentiments associated with each content item using any suitable mechanism such as a machine learning classifier. For example, in some embodiments, process 100 can use a cosine similarity score to determine the likelihood or probability that the plurality of advertiser sentiments is similar to each of the plurality of sentiments for the one or more content items. For example, in some embodiments, process 100 can determine a likelihood that the advertiser sentiments of {“responsive to patients,” “evidence-based care”} are similar to the second content item sentiments of {“real estate,” “woman smiling,” “agency name,” “agency phone number”}. In this particular example, at block 108, process 100 can determine the likelihood to be “0.55” or 55%.

In some embodiments, at block 108, process 100 can determine a series of similarity scores by iterating through all possible pairings of an advertiser sentiment from the plurality of advertiser sentiments and a content sentiment from the plurality of sentiments for a given content item. In some embodiments, at block 108, process 100 can determine an overall similarity score for the given content item by aggregating the series of similarity scores using any suitable mechanism (e.g., average, mean, median, weighted average, etc.).

Although block 108 has been described with respect to processing textual combinations, it should be noted that advertiser sentiments can be submitted to process 100 as images, and that process 100 can perform image recognition on the images representing the advertiser sentiments to determine a plurality of advertiser sentiments. Additionally, block 108 can alternatively receive the image identified at block 104 and can determine a similarity score between pairs of images, e.g., a first image representing an advertiser sentiment and a second image being the content item identified in the dynamic advertising area.

Similarly, advertiser sentiments can be submitted to process 100 as video and/or audio, and process 100 can perform any suitable combination of image and/or audio recognition to determine a plurality of advertiser sentiments.

In some embodiments, process 100 can loop 110 through blocks 104-108 with any suitable frequency. For example, in some embodiments, process 100 can perform loop 110 by causing the webpage to be refreshed and by identifying a new content item shown in the same position of the dynamic advertisement. Continuing this example, in some embodiments, process 100 can determine sentiments at block 106 and a similarity score at block 108 as described above for each iteration of loop 110. In some embodiments, process 100 can store data from each loop 110, such as an indication of the image, sentiments, and/or similarity scores determined at blocks 104, 106, and 108, respectively, for each iteration of loop 110.

Continuing to block 112, process 100 can determine any suitable aggregate similarity score and/or statistics based on the similarity scores determined at block 108, using for example, a machine learning classifier. In some embodiments, the aggregate similarity score can be any suitable combination and/or output of a calculation using the similarity scores. For example, the aggregate similarity score can be a sum, a weighted sum, a maximum value, a minimum value, and/or any other representative value from the similarity scores. In another example, in addition to the content analysis described above, the machine learning classifier can incorporate additional parameters or statistics, such as a historical count (e.g., a number of times) of bid wins per advertising area, advertisement slot, or domain for an advertiser; a historical hit rate per domain (e.g., the number of bid wins divided by the number of bid attempts in an advertisement bidding system); contextual and avoidance segment identifiers that were recorded for historical impressions; etc.

In some embodiments, at block 112, a weighted sum can additionally use the position of each content item within the webpage to weight the similarity score. For example, an advertiser that provided advertiser sentiments can weight advertising regions that are positioned lower on a webpage as lower in the aggregate similarity score calculation. That is, in some embodiments, if a particular image (that can potentially be brand-unsafe for the advertiser, based on a low similarity score) appears in the webpage but the image is located farther from the top of the webpage and/or away from a particular dynamic advertising region where the advertiser can place an advertisement, process 100 can place a lower weight on the similarity score for that particular image based on the position information for that image determined at block 104.

In another example, process 100 can determine that the similarity scores follow a particular statistical distribution such as a normal distribution and/or a bi-modal distribution. In yet another example, in some embodiments, process 100 can determine the mean of the similarity scores, and can additionally determine the standard deviation from the mean of the similarity scores. Continuing this example, process 100 can determine that a particular similarity score is a statistical outlier, for example, by determining that within the distribution of similarity scores, a particular similarity score is at least two or more standard deviations from the mean of the similarity scores. In some embodiments, at block 112, process 100 can discard any statistical outliers from the aggregate of similarity scores. In some embodiments, at block 112, process 100 can alternatively flag any statistical outliers as being potentially brand-unsafe for the advertiser and can continue to block 116 as described below.

In some embodiments, at block 112, process 100 can compare the aggregate similarity score to a threshold value. In some embodiments, the threshold value can be a constant numeric value that is set by the advertiser that is requesting the contextual advertising analysis. In some embodiments, the threshold value can be a first range of predetermined values.

In some embodiments, at block 112, process 100 can determine that the aggregate similarity score is above the threshold value (e.g., within the first range of predetermined values) and can continue to block 114.

In some embodiments, at 114, process 100 can determine that the advertisements shown on the webpage received at block 102 are brand-safe for the advertiser that provided the advertising sentiments. In some embodiments, process 100 can associate the webpage with an advertising approval list for the advertiser. In some embodiments, process 100 can determine that the webpage was previously associated with an advertising exclusion list for the advertiser, (e.g., from a previous instance of process 100) and can additionally remove the webpage from the exclusion list for the advertiser. In some embodiments, process 100 can additionally and/or alternatively provide a recommendation to place a bid for advertising in a particular region within the webpage. For example, as shown in FIG. 3 and discussed below, advertiser 340 can submit a bid to ad network 302 for advertising within dynamic advertising region 206 based on a recommendation from process 100.

In some embodiments, at block 112, process 100 can alternatively determine that the aggregate similarity score is within a second range of predetermined values, the first range of predetermined values not overlapping with the second range of predetermined values, and can continue to block 116. In some embodiments, determining that the aggregate similarity score is within the second range of predetermined values can comprise determining that the aggregate similarity score is equal to or below the threshold value.

In some embodiments, at 116, process 100 can determine that the advertisements shown on the webpage received at block 102 are not brand-safe for the advertiser that provided the advertising sentiments. In some embodiments, process 100 can associate the webpage with an advertising exclusion list for the advertiser. In some embodiments, process 100 can determine that the webpage was previously associated with an advertising approval list for the advertiser, (e.g., from a previous instance of process 100) and can additionally remove the webpage from the approval list for the advertiser. In some embodiments, process 100 can additionally and/or alternatively provide a recommendation to not place a bid for advertising in a particular region within the webpage. For example, as shown in FIG. 3 and discussed below, advertiser 330 can decline to submit a bid to ad network 302 for advertising within dynamic advertising region 206 based on a recommendation from process 100.

Turning to FIG. 2, an illustrative webpage 200 containing dynamic advertising regions in accordance with some embodiments of the disclosed subject matter is shown. In some embodiments, webpage 200 can be assigned a web address 202 and can contain webpage content 204, and advertising regions 206-212.

In some embodiments, webpage 200 can be displayed on any suitable device, such as display devices 512 of servers 402 and/or user devices 406. In some embodiments, the arrangement of webpage content 204 and advertising regions 206-212 can be determined based on the type of device (e.g., desktop computer with monitor, mobile phone, etc.) used to access webpage 200. In some embodiments, any suitable additional elements can be included in webpage 200, such as login prompts, navigation tabs, navigation links, image carousels, e-commerce functions (e.g., “add to cart”, “qty”, select a size and/or color from a drop-down list, etc.) including a shopping cart feature.

In some embodiments, web address 202 can have any suitable syntax (e.g., universal resource identifier, URI) and can, for example, include a protocol, a hostname, a domain name, a directory, a filename, and/or a path. In some embodiments, web address 202 can include any suitable characters, such as ASCII, Unicode, and/or any other suitable characters.

In some embodiments, webpage content 204 can include any suitable arrangement and/or layout of text, imagery, static and/or interactive graphics (e.g., charts, graphs, maps, etc.), audio, video, and/or other web design content (e.g., navigation menus, pop-ups, scroll animation, selectable icons, text-entry forms, log-in container, search bar, etc.), and/or any suitable combination thereof. For example, webpage content 204 can include a blog post and can include a heading section and a main body section, where the heading section is a first typeface and the main body is a second typeface. In another example, in some embodiments, webpage content 204 can include embedded images such as a photograph and/or a series of photographs in any suitable container (e.g., slideshow, carousel, etc.). In another example, in some embodiments, webpage content 204 can include a video player and can start playback of the video content at any suitable time, including auto-playing when a user scrolls past the video player.

In some embodiments, webpage 200 can include any suitable quantity of advertisements, such as advertising regions 206-212. In some embodiments, first advertising region 206 can be a banner advertisement and can be located in any suitable position on webpage 200. In some embodiments, second, third, and fourth advertising regions 208, 210, and 212 (respectively) can be positioned in a column adjacent to webpage content 204, such that a person viewing web address 202 would see content placed in the fourth advertising region 212 after scrolling through the webpage.

In some embodiments, advertising regions 206-212 can be configured to display advertising content, such as images with text and/or visual content that is created to give a particular brand association. For example, in some embodiments, a name of a company and a logo can appear in any one of the advertising regions 206-212.

In some embodiments, advertising regions 206-212 can be configured to display advertising content that can be updated and/or changed dynamically. That is, in some embodiments, advertising regions 206-212 can be dynamic advertising regions. For example, in some embodiments, advertising regions 206-212 can be configured to refresh the content in each advertising region with each refresh of webpage 200, as indicated by a browser and/or application that is used to access webpage 200. In another example, in some embodiments, advertising regions 206-212 can be configured to refresh the content in the respective advertising region after being viewed for any suitable duration (e.g., 1 second, 5 seconds, 10 seconds, etc.). In this example, any suitable mechanism can be used to determine advertisement view duration. In yet another example, in some embodiments, advertising regions 206-212 can be configured to display in the respective advertising region based on any suitable user behavior, such as scrolling a certain amount of the webpage, hovering in any particular spot within webpage 200, etc.

In some embodiments, the dynamic features of advertising regions 206-212 can receive advertising content (e.g., display advertisements) from any suitable mechanism. For example, in some embodiments, a domain associated with hosting webpage 200 can provide advertising content to webpage 200. In another example, advertising regions 206-212 can receive content from an advertising network. As a particular example, as illustrated in example auction 300 of FIG. 3, advertising region 206 can be auctioned on an advertising network such as advertising network 302. As illustrated, in some embodiments, advertisers 310-340 can be members of the advertising network 302 and can participate in auctions for digital advertising placement hosted by advertising network 302.

In some embodiments, advertising network 302 can host any suitable quantity of auctions for digital advertisements. In some embodiments, advertising network 302 can host auctions for display advertisements on webpages and/or within applications, videos, and/or any other digital space; sponsored advertisements; targeted advertisements; search advertisements; video advertisements; and/or any other suitable type of digital advertisement. In some embodiments, advertising network 302 can facilitate delivering an image submitted by an advertiser to a digital advertising region, such as advertising regions 206-212 as shown on webpage 200 in connection with FIG. 2, as discussed above. In some embodiments, advertising regions 206-212 can be auctioned separately within advertising network 302. That is, in some embodiments, an advertising broker can run independent auctions for displaying advertisements in dynamic advertising regions 206 and 208, and advertisers who place bids in an auction for advertising region 206 can be unaware of any auction activity (e.g., auction participants, auction winner) for advertising region 208.

In some embodiments, advertising network 302 can support auctions that use any suitable auction logic, auction placement of dynamic advertising regions using any suitable auction logic, such as a second-price auction, a first-price auction, and/or any other suitable type of auction. In some embodiments, advertising placement can be auctioned using any suitable metric, such as a number of impressions (e.g., cost per mille, or CPM), a number of site visits, duration of time (e.g., number of days to run a campaign), etc.

In some embodiments, advertisers 310-340 can join auction 300 using any suitable mechanism. In some embodiments, advertisers 310-340 can be members within advertising network 302, and can automatically find auctions such as auction 300 using any suitable filtering criteria and/or targets. In some embodiments, advertisers 310-340 can be any suitable content publisher, advertising agency, in-house marketing organization, and/or any other suitable representative of a business that sells goods and/or services and that has a digital marketing campaign.

In some embodiments, advertisers 310-340 can view the information associated with the advertising region 206 prior to placing a bid for displaying a display advertisement in the advertising region. That is, in some embodiments, advertising network 302 can provide any suitable information (e.g., web address 202, domain, content tag(s), historical visitor counts, historical visitor demographics, click-through-rates, view times, etc.) to advertisers 310-340 regarding the webpage (e.g., webpage 200) where the digital advertising asset being auctioned in auction 300 (e.g., advertising region 206) is located. In some embodiments, advertisers 310-340 can submit images and/or other content (e.g., display advertisements 312, 322, 332, and/or 342) to the advertising network 302 as part of the bidding and auction process. In some embodiments, advertising network 302 can accept any suitable size and format of images, including a size of image (e.g., pixel width and/or height) that is different than a size of advertising region available in the auction. In some embodiments, advertisers 310-340 can submit any other suitable information to the advertising network 302, such as a destination web address, wherein the destination web address is used to redirect a user who clicks on the dynamic advertising region while the respective advertising image is displayed.

In some embodiments, a first advertiser 310 (e.g., urgent care clinic) can have associated brand sentiments 1 and 2 (e.g., responsive to patients, evidence-based care, etc.). In some embodiments, advertiser 310 can be running an advertising campaign using display advertisement 312 containing imagery (e.g., a healthcare practitioner wearing a stethoscope) and text related to the brand sentiments 1 and 2. In some embodiments, advertiser 310 can use any suitable mechanism and/or information to place a bid such as Bid 1. In some embodiments, advertiser 310 can submit display advertisement 312 to ad network 302 as part of Bid 1, along with any suitable additional bidding information (e.g., price that advertiser 310 will pay, etc.).

In some embodiments, a second advertiser 320 (e.g., spiritual healer) can have associated brand sentiments A and B (e.g., use of crystals, contacting spirits, etc.). In some embodiments, advertiser 320 can be running an advertising campaign using display advertisement 322 containing imagery (e.g., set of crystal decoration) and text related to the brand sentiments A and B. In some embodiments, advertiser 320 can use any suitable mechanism and/or information to place a bid such as Bid 2. In some embodiments, advertiser 320 can submit display advertisement 322 to ad network 302 as part of Bid 2, along with any suitable additional bidding information (e.g., price that advertiser 320 will pay, etc.).

In some embodiments, a third advertiser 330 (e.g., fast food restaurant) can have associated brand sentiments X and Y (e.g., fresh cooked hamburgers, fast service, etc.). In some embodiments, advertiser 330 can be running an advertising campaign using display advertisement 332 containing imagery (e.g., a seated customer eating a hamburger) and text related to the brand sentiments X and Y. In some embodiments, advertiser 330 can use any suitable mechanism and/or information, such as for example process 100, to receive additional context for the webpage 200 in which dynamic advertising region 206 is positioned. For example, in some embodiments, advertiser 330 can check the web address 202 against a directory of brand-safe domains. That is, in some embodiments, advertiser 330 can be aware that webpage 200 contains multiple regions of dynamic advertising such as dynamic advertising regions 206-212. In this example, in some embodiments, advertiser 330 can decline to place a bid for dynamic advertising region 206 after any suitable mechanism (such as process 100) determines that other advertisers who have previously won bids for display advertisements (e.g., for advertising region 208) on webpage 200 are not brand-safe for the brand sentiments of advertiser 330. As a particular example, in some embodiments, process 100 can determine that advertisements from advertiser 340 containing sentiments of vegetarianism and animal welfare have previously appeared in dynamic advertising regions on webpage 200, and that these sentiments (vegetarianism and animal welfare) are not compatible with the brand sentiments of advertiser 330 and display advertisement 332.

In some embodiments, a fourth advertiser 340 (e.g., animal welfare organization) can have associated brand sentiments 3 and 4 (e.g., vegetarian, animal welfare, etc.). In some embodiments, advertiser 340 can be running an advertising campaign using display advertisement 342 containing imagery (e.g., caring hands and cat) and text related to the brand sentiments 3 and 4. In some embodiments, advertiser 340 can use any suitable mechanism and/or information, such as for example process 100, to receive additional context for the webpage 200 in which dynamic advertising regions 206 and 208 are positioned. For example, in some embodiments, advertiser 340 can be aware that webpage 200 contains multiple regions of dynamic advertising such as dynamic advertising regions 206-212. In this example, in some embodiments, advertiser 340 can proceed to place a bid for dynamic advertising region 206 after any suitable mechanism (such as process 100) can determine that other advertisers who have previously won bids for display advertisements on webpage 200 are brand-safe for advertiser 340 and display advertisement 342.

Turning to FIG. 4, an example 400 of hardware for providing digital advertisers improved context for dynamic webpages in accordance with some implementations is shown. As illustrated, hardware 400 can include a server 402, a communication network 404, and/or one or more user devices 406, such as user devices 408 and 410.

Server 402 can be any suitable server(s) for storing information, data, programs, media content, and/or any other suitable content. In some implementations, server 402 can perform any suitable function(s). For example, in some embodiments, server 402 can host any suitable website and/or Internet-enabled application, such as webpage 202 discussed above in connection with FIG. 2.

Communication network 404 can be any suitable combination of one or more wired and/or wireless networks in some implementations. For example, communication network can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 406 can be connected by one or more communications links (e.g., communications links 412) to communication network 404 that can be linked via one or more communications links (e.g., communications links 414) to server 402. The communications links can be any communications links suitable for communicating data among user devices 406 and server 402 such as network links, dial-up links, wireless links, hard-wired links, any other suitable communications links, or any suitable combination of such links.

User devices 406 can include any one or more user devices suitable for use with process 100. In some implementations, user device 406 can include any suitable type of user device, such as speakers (with or without voice assistants), mobile phones, tablet computers, wearable computers, laptop computers, desktop computers, smart televisions, media players, game consoles, vehicle information and/or entertainment systems, and/or any other suitable type of user device.

Although server 402 is illustrated as one device, the functions performed by server 402 can be performed using any suitable number of devices in some implementations. For example, in some implementations, multiple devices can be used to implement the functions performed by server 402.

Although two user devices 408 and 410 are shown in FIG. 4 to avoid overcomplicating the figure, any suitable number of user devices, (including only one user device) and/or any suitable types of user devices, can be used in some implementations.

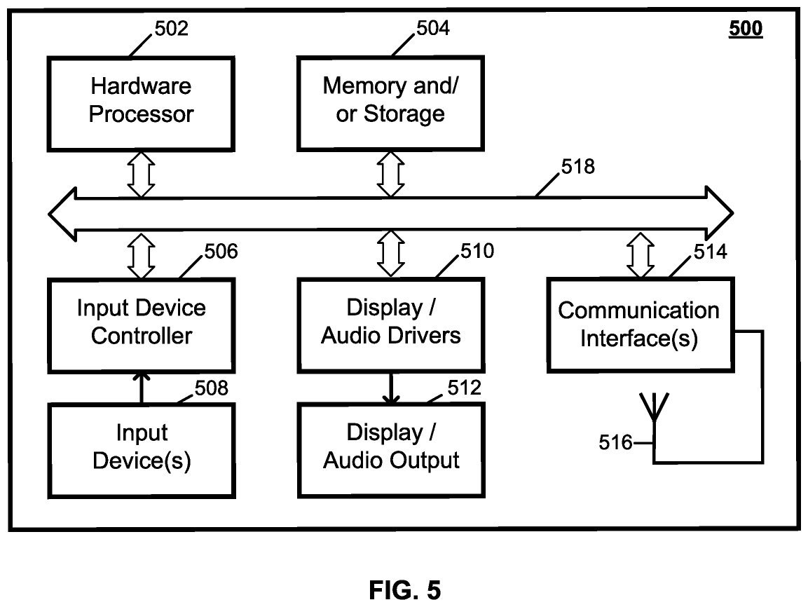

Server 402 and user devices 406 can be implemented using any suitable hardware in some implementations. For example, in some implementations, devices 402 and 406 can be implemented using any suitable general-purpose computer or special-purpose computer and can include any suitable hardware. For example, as illustrated in example hardware 500 of FIG. 5, such hardware can include hardware processor 502, memory and/or storage 504, an input device controller 506, an input device 508, display/audio drivers 510, display and audio output circuitry 512, communication interface(s) 504, an antenna 516, and a bus 518.

Hardware processor 502 can include any suitable hardware processor, such as a microprocessor, a micro-controller, digital signal processor(s), dedicated logic, and/or any other suitable circuitry for controlling the functioning of a general-purpose computer or a special-purpose computer in some implementations. In some implementations, hardware processor 502 can be controlled by a computer program stored in memory and/or storage 504. For example, in some implementations, the computer program can cause hardware processor 502 to perform functions described herein.

Memory and/or storage 504 can be any suitable memory and/or storage for storing programs, data, documents, and/or any other suitable information in some implementations. For example, memory and/or storage 504 can include random access memory, read-only memory, flash memory, hard disk storage, optical media, and/or any other suitable memory.

Input device controller 506 can be any suitable circuitry for controlling and receiving input from one or more input devices 508 in some implementations. For example, input device controller 506 can be circuitry for receiving input from a touchscreen, from a keyboard, from a mouse, from one or more buttons, from a voice recognition circuit, from one or more microphones, from a camera, from an optical sensor, from an accelerometer, from a temperature sensor, from a near field sensor, and/or any other type of input device.

Display/audio drivers 510 can be any suitable circuitry for controlling and driving output to one or more display/audio output devices 512 in some implementations. For example, display/audio drivers 510 can be circuitry for driving a touchscreen, a flat-panel display, a cathode ray tube display, a projector, a speaker or speakers, and/or any other suitable display and/or presentation devices.

Communication interface(s) 514 can be any suitable circuitry for interfacing with one or more communication networks, such as network 404 as shown in FIG. 4. For example, interface(s) 514 can include network interface card circuitry, wireless communication circuitry, and/or any other suitable type of communication network circuitry.

Antenna 516 can be any suitable one or more antennas for wirelessly communicating with a communication network (e.g., communication network 404) in some implementations. In some implementations, antenna 516 can be omitted.

Bus 518 can be any suitable mechanism for communicating between two or more components 502, 504, 506, 510, and 514 in some implementations.

Any other suitable components can be included in hardware 500 in accordance with some implementations.

In some implementations, any suitable computer readable media can be used for storing instructions for performing the functions and/or processes described herein. For example, in some implementations, computer readable media can be transitory or non-transitory. For example, non-transitory computer readable media can include media such as non-transitory forms of magnetic media (such as hard disks, floppy disks, etc.), non-transitory forms of optical media (such as compact discs, digital video discs, Blu-ray discs, etc.), non-transitory forms of semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

It should be understood that at least some of the above-described blocks of process 100 can be executed or performed in any order or sequence not limited to the order and sequence shown in and described in connection with FIG. 1. Also, some of the above blocks of process 100 can be executed or performed substantially simultaneously where appropriate or in parallel to reduce latency and processing times. Additionally or alternatively, some of the above described blocks of process 100 can be omitted.

Accordingly, methods, systems, and media for providing digital advertisers improved context for dynamic webpages are provided.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for providing contextual information associated with pages containing dynamic content, the method comprising:
accessing a webpage that contains at least one dynamic advertising region;
receiving a plurality of brand sentiments associated with a first advertiser;
identifying a position of the at least one dynamic advertising region in the webpage and at least one content item shown in proximity to the at least one dynamic advertising region;
determining, using a machine learning classifier,
(i) a plurality of sentiments for the at least one content item shown in proximity to the at least one dynamic advertising region;
(ii) a plurality of similarity scores, wherein each similarity score is a probability that a sentiment from the plurality of sentiments for the at least one content item is similar to a sentiment from the plurality of brand sentiments; and
(iii) an aggregate similarity score based on the plurality of similarity scores; and
in response to determining that the aggregate similarity score is within a first range of predetermined values, associating the webpage with an approval list associated with the first advertiser.

2. The method of claim 1, wherein the method further comprises causing the first advertiser to place a bid for advertising in the at least one dynamic advertising region on the webpage in response to the webpage being associated with the approval list.

3. The method of claim 1, wherein the method further comprises:
determining that the aggregate similarity score based on the plurality of similarity scores is within a second range of predetermined values, wherein the second predetermined range of values does not overlap with the first predetermined range of values; and
in response to determining the aggregate similarity score is within the second range of predetermined values, associating the webpage with an exclusion list associated with the first advertiser.

4. The method of claim 3, wherein the method further comprises inhibiting the first advertiser from placing a bid for advertising in the at least one dynamic advertising region on the webpage in response to the webpage being associated with the exclusion list.

5. The method of claim 1, wherein the method further comprises:
determining, prior to accessing to the webpage that contains the at least one dynamic advertising region, that the webpage is included on an exclusion list associated with the first advertiser; and
in response to determining that the aggregate similarity score associated with the webpage is within the first predetermined range of values, removing the webpage from the exclusion list associated with the first advertiser and adding the webpage on the approval list associated with the first advertiser.

6. The method of claim 1, wherein the method further comprises:
determining, prior to accessing to the webpage that contains the at least one dynamic advertising region, that the webpage is included on the approval list associated with the first advertiser; and
in response to determining that the aggregate similarity score associated with the webpage is within a second predetermined range of values, removing the webpage from the approval list associated with the first advertiser and adding the webpage on an exclusion list associated with the first advertiser.

7. The method of claim 1, wherein the aggregate similarity score is a weighted sum of the plurality of similarity scores, wherein the position of the at least one dynamic advertising region is used to weight the plurality of similarity scores.

8. The method of claim 1, wherein the webpage is selected based on a determination that the webpage contains content that is relevant for the first advertiser.

9. The method of claim 1, wherein the method further comprises associating the plurality of advertising sentiments, the at least one content item, the plurality of sentiments for the at least one content item, the plurality of similarity scores, and the aggregate similarity score with a training dataset for the machine learning model.

10. A system for providing contextual information associated with pages containing dynamic content, the system comprising:
a hardware processor that is configured to:
access a webpage that contains at least one dynamic advertising region;
receive a plurality of brand sentiments associated with a first advertiser;
identify a position of the at least one dynamic advertising region in the webpage and at least one content item shown in proximity to the at least one dynamic advertising region;
determine, using a machine learning classifier,
(i) a plurality of sentiments for the at least one content item shown in proximity to the at least one dynamic advertising region;
(ii) a plurality of similarity scores, wherein each similarity score is a probability that a sentiment from the plurality of sentiments for the at least one content item is similar to a sentiment from the plurality of brand sentiments; and
(iii) an aggregate similarity score based on the plurality of similarity scores; and
in response to determining that the aggregate similarity score is within a first range of predetermined values, associate the webpage with an approval list associated with the first advertiser.

11. The system of claim 10, wherein the hardware processor is further configured to cause the first advertiser to place a bid for advertising in the at least one dynamic advertising region on the webpage in response to the webpage being associated with the approval list.

12. The system of claim 10, wherein the hardware processor is further configured to:
determining that the aggregate similarity score based on the plurality of similarity scores is within a second range of predetermined values, wherein the second predetermined range of values does not overlap with the first predetermined range of values; and
in response to determining the aggregate similarity score is within the second range of predetermined values, associating the webpage with an exclusion list associated with the first advertiser.

13. The system of claim 12, wherein the hardware processor is further configured to inhibit the first advertiser from placing a bid for advertising in the at least one dynamic advertising region on the webpage in response to the webpage being associated with the exclusion list.

14. The system of claim 10, wherein the hardware processor is further configured to:
determine, prior to accessing to the webpage that contains the at least one dynamic advertising region, that the webpage is included on an exclusion list associated with the first advertiser; and
in response to determining that the aggregate similarity score associated with the webpage is within the first predetermined range of values, remove the webpage from the exclusion list associated with the first advertiser and add the webpage on the approval list associated with the first advertiser.

15. The system of claim 10, wherein the hardware processor is further configured to:
determine, prior to accessing to the webpage that contains the at least one dynamic advertising region, that the webpage is included on the approval list associated with the first advertiser; and
in response to determining that the aggregate similarity score associated with the webpage is within a second predetermined range of values, remove the webpage from the approval list associated with the first advertiser and add the webpage on an exclusion list associated with the first advertiser.

16. The system of claim 10, wherein the aggregate similarity score is a weighted sum of the plurality of similarity scores, wherein the position of the at least one dynamic advertising region is used to weight the plurality of similarity scores.

17. The system of claim 10, wherein the webpage is selected based on a determination that the webpage contains content that is relevant for the first advertiser.

18. The system of claim 10, wherein the hardware processor is further configured to associate the plurality of advertising sentiments, the at least one content item, the plurality of sentiments for the at least one content item, the plurality of similarity scores, and the aggregate similarity score with a training dataset for the machine learning model.

19. A computer-readable medium containing computer executable instructions that, when executed by a processor, cause the processor to perform a method for providing contextual information associated with pages containing dynamic content, the method comprising:
accessing a webpage that contains at least one dynamic advertising region;
receiving a plurality of brand sentiments associated with a first advertiser;
identifying a position of the at least one dynamic advertising region in the webpage and at least one content item shown in proximity to the at least one dynamic advertising region;
determining, using a machine learning classifier,
(i) a plurality of sentiments for the at least one content item shown in proximity to the at least one dynamic advertising region;
(ii) a plurality of similarity scores, wherein each similarity score is a probability that a sentiment from the plurality of sentiments for the at least one content item is similar to a sentiment from the plurality of brand sentiments; and
(iii) an aggregate similarity score based on the plurality of similarity scores; and
in response to determining that the aggregate similarity score is within a first range of predetermined values, associating the webpage with an approval list associated with the first advertiser.
